(19) United States
(12) Patent Application Publication
(10) Pub. No.: US 2006/0173564 A1
(43) Pub. Date: Aug. 3, 2006

(54) Audio recording and playback device

(75) Inventor: Joseph L. Beverly, Norcross, GA (US)

Correspondence Address: TROUTMAN SANDERS LLP, 600 PEACHTREE STREET , NE, ATLANTA, GA, 30308, US

(73) Assignee: Adaptable Systems Corporation, Norcross, GA (US)

(21) Appl. No.: 11/343,795

(22) Filed: Jan. 31, 2006

Related U.S. Application Data
(60) Provisional application No. 60/648,948, filed on Feb. 1, 2005.

(51) Int. Cl. G06F 17/00; G10L 21/00

(52) U.S. Cl. 700/94; 704/272

(57) ABSTRACT

A reusable, preferably disposable, miniature, short duration audio recording and playback device having a microphone for receiving audio; a speaker for emitting audio; a recording and playback unit adapted to record audio received by the microphone and playback stored audio via the speaker; a memory storage device adapted to store no more than sixty seconds of audio data; a power supply for supplying power to at least one of the microphone, speaker, recording and playback unit, and memory storage device; and a housing having an attachment mechanism and adapted to receive the microphone, speaker, recording and the playback unit, memory storage device, and power supply. The housing includes a length dimension of approximately 3.25 inches, a width dimension of approximately 2 inches, a thickness dimension of approximately 4 millimeters, and a weight of approximately 1.5 ounces.

### CROSS-REFERENCE TO A RELATED APPLICATION

This application claims the benefit of U.S. Provisional Application 60/648,948, filed on Feb. 1, 2005, the entirety of which is incorporated herein by reference.

### BACKGROUND OF THE INVENTION

1. Field of the Invention

The present invention relates generally to an audio recording and playback device, and more particularly to a reusable, disposable, miniature short duration audio recording and playback device.

2. Description of the Related Art

Traditionally, the use of written messages has been the predominant method of note communication. Utilizing a writing utensil, such as a pen or pencil, an individual routinely jots down a message on a piece of scratch paper or POST-IT® note, which is then left for the intended recipient. Handwritten notes or messages, however, are not always the most efficient or effective form of brief communication. Inevitably, there are situations in which the individual leaving the note or message cannot fit the intended communication on the limited space of the scratch paper or POST-IT® note. Further, the individual may be in such a hurry in writing the message that the individual's handwriting cannot be easily deciphered by the recipient, or the message may be purposely truncated, thereby missing particular and important details. As in all forms of written communication, the ability to convey the true meaning of handwritten notes is diminished by the reader's inability to determine the subtle meanings the sender intended, as the reader cannot draw inference from the sender's tone of voice or emotion (e.g., sarcasm is often undetectable in written communications).

Conventional voice communications generally involve the use of a cumbersome, inconvenient, and clumsy audio recording device that is designed to store large amounts of voice recordings on removable media (e.g., a tape cassette). In order to listen to the voice communication, the recipient must possess an audio playback device capable of utilizing the removable media. Use of such a device for message communication is often too inconvenient and burdensome for the sender and recipient of the message, and often wastes a majority of the removable media, as a brief message generally utilizes a small portion of the removable media's storage capacity. Alternatively, voicemail is used through a telephone system to leave voice communications, but is not always practical as the voicemail cannot be attached to an object, such as a document or file.

What is needed is a reusable, miniature, short duration audio recording and playback device that will save time and money lost due to misunderstood instructions and misconstrued meaning in written communications, while providing a convenient, inexpensive alternative to conventional audio recording devices. It is to such a device that the present invention is primarily directed.

### BRIEF SUMMARY OF THE INVENTION

Briefly described, in preferred form, the present invention is reusable, preferably disposable, miniature, short duration audio recording and playback device having a microphone for receiving audio; a speaker for emitting audio; a recording and playback unit adapted to record audio received by the microphone and playback stored audio via the speaker; a memory storage device adapted to store the audio data; a power supply for supplying power to at least one of the microphone, speaker, recording and playback unit, and memory storage device; and a housing having an attachment mechanism and adapted to receive the microphone, speaker, recording and the playback unit, memory storage device, and power supply. The housing includes a length dimension of approximately 3.25 inches, a width dimension of approximately 2 inches, a thickness dimension of approximately 4 millimeters, and a weight of approximately 1.5 ounces.

More particularly, the present invention relates to a credit card sized audio recording and playback device, approximately 4 millimeters in depth, that allows the recording and/or appending of audio message(s) up to 60 seconds long and playback of same, such that the audio recording and playback device is powered by a power source, such as a battery, made of ultra thin layered material weighing less than a gram and about 0.5 mils thick.

The audio recording and playback device permits the exchange of short duration communications between individuals for, but not limited to, military, business, education, promotion and/or personal purposes by attachment to documents or other materials forwarded therewith.

These and other objects, features and advantages of the present invention will become more apparent upon reading the following specification in conjunction with the accompanying drawings.

### BRIEF DESCRIPTION OF THE FIGURES

FIGS. 1A-1C, collectively known as FIG. 1, illustrate front, back, and top views of an audio recording and playback device in accordance with preferred embodiments of the present invention.

FIG. 2 illustrates a block diagram of an audio recording and playback system in accordance with preferred embodiments of the present invention.

FIGS. 3A-3B, collectively known as FIG. 3, illustrate a flow diagram representation of a method of recording audio on an audio recording and playback device in accordance with preferred embodiments of the present invention.

FIG. 4 illustrates a flow diagram representation of a method of playing back audio stored on an audio recording and playback device in accordance with preferred embodiments of the present invention.

FIG. 5 illustrates a flow diagram representation of a method of deleting stored audio from an audio recording and playback device in accordance with preferred embodiments of the present invention.

### DETAILED DESCRIPTION OF THE PREFERRED EMBODIMENTS

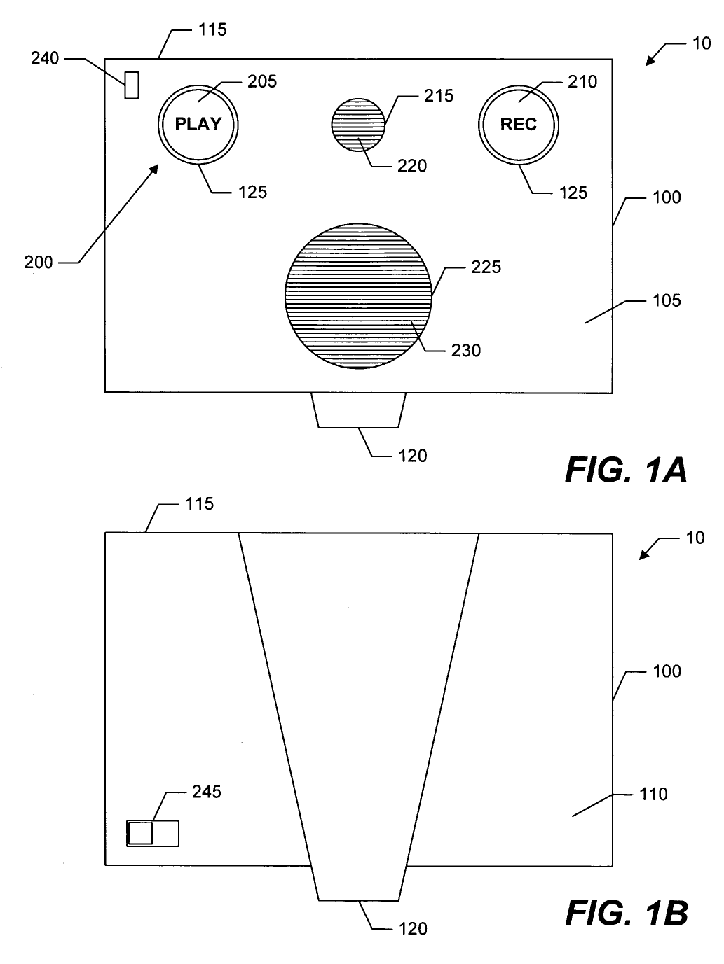

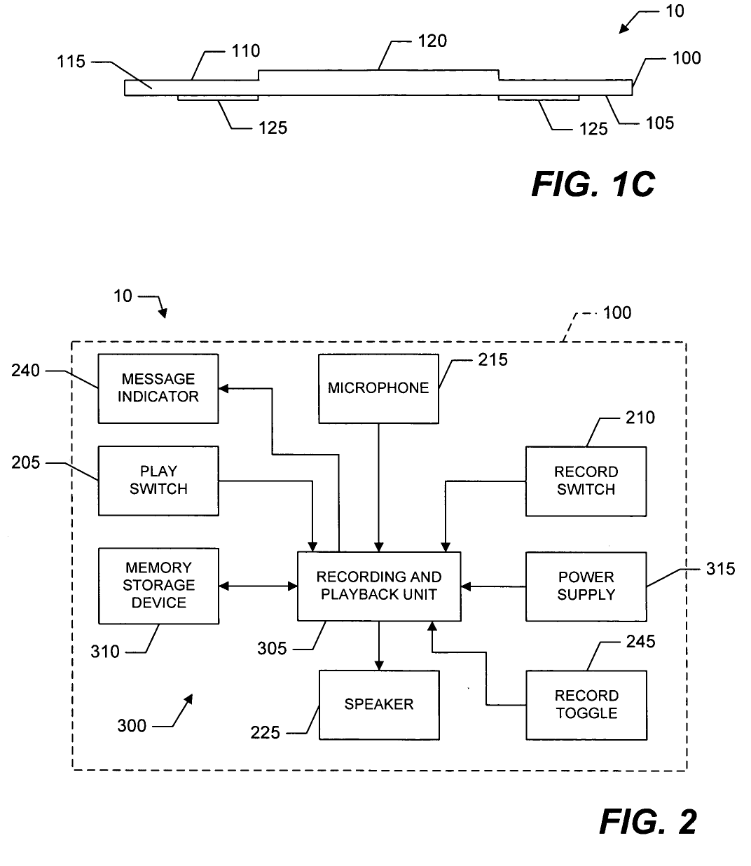

Referring now in detail to the drawing figures, wherein like reference numerals represent like parts throughout the several views, an audio recording and playback device 10 of FIG. 1 provides for the recording of audio having a predetermined duration and for the subsequent playback of the stored audio upon request by an individual. The audio recording and playback device 10 is compactly designed for the iterative recording and playing of audio, such as voice messages, having a short duration, such that the audio recording and playback device 10 can be effectively stored with or attached to an object (e.g., a document or file). Further, the audio recording and playback device 10 includes cost-effective components, thereby rendering the audio recording and playback device 10 disposable, yet reusable.

As shown in FIGS. 1A-1C, the audio recording and playback device 10 comprises a housing 100 and a user interface 200. The housing 100 is adapted to receive the user interface 200, so that an individual can effectively utilize the user interface 200 to activate the audio recording and playback device 10. The user interface 200 is adapted to activate the audio recording and playback device 10 from a standby mode to a recording mode or a playback mode. During the recording mode, the audio recording and playback device 10 receives and records audio. During the playback mode, the audio recording and playback device 10 plays or emits the stored audio.

More specifically, the housing 100 includes a top 105, a bottom 110, and a peripheral side wall 115 extending from the top 105 to the bottom 110, such that a cavity is defined between the top 105 and the bottom 110 of the housing 100. The housing 100 can further comprise an attachment mechanism 120 adapted to attach or fasten the audio recording and playback device 10 to an object (i.e., a tangible, physical, and concrete structure), such as, but not limited to, a document, file, mirror, door, window, refrigerator, or mailbox. The attachment mechanism 120 is generally positioned on the bottom 110 of the housing 100, whereby the top 105 of the housing 100 faces outwardly when the audio recording and playback device 10 is attached to an object. One skilled in the art will recognize that the attachment mechanism 120 can include a clip, clamp, magnet, button, bolt, wire, pin, temporary adhesive or other suitable attachment instrumentality. In a preferred embodiment of the present invention, the attachment mechanism 120 is integrated with the bottom 110 of the housing, such that the attachment mechanism 120 distributes the weight of the audio recording and playback device 10 over a large area, and thus enables the device to be attached to a related object without causing damage or distortion to the object, if desired.

Although the housing 100 can be configured in a variety of shapes and sizes within the scope of the present invention, in one embodiment the housing 100 includes a shape and size generally similar to that of a credit card. To promote a compact design of the audio recording and playback device 10, the corresponding top 105 and bottom 110 of the housing 100 can measure approximately two inches in width and three and a quarter inches in length. Further, the thickness of the housing 100 (e.g., the height of the peripheral side wall 115, or the distance between the top 105 and bottom 110 of the housing 100) can be approximately four millimeters. Such a miniature size promotes portability and applicability of the audio recording and playback device 10.

The user interface 200 is received by the housing 100, such that the user interface 200 is generally positioned on the top 105 and the bottom 110 of the housing 100, but is also in communication with the cavity defined within the housing 100. More specifically, the user interface 200 can comprise a play switch 205, a record switch 210, a microphone 215, and a speaker 225. Generally, the play switch 205, record switch 210, microphone 215 and speaker 225 are positioned on the top 105 of the housing 100, facing outwardly.

When triggered, the play switch 205 activates the audio recording and playback device 10 into the playback mode, wherein recorded audio is provided to the speaker 225 to be emitted outwardly from the top 105 of the housing 100. Accordingly, when a user pushes the play switch 205, the user can listen to the audio message that had been previously recorded on the audio recording and playback device 10. Similarly, when the record switch 210 is triggered, the audio recording and playback device 10 is activated into the record mode, wherein audio is received by the microphone 215 and then stored on the audio recording and playback device 10 for subsequent playback. Preferably, the play switch 205 and the record switch 210 include domed buttons for allowing the user to easily trigger the play switch 205 and the record switch 210.

To prevent accidental triggering of the record switch 210 and/or the play switch 205, the housing 100 can include at least one switch guard 125 extending outwardly from the top 105 of the housing 100 and positioned along the perimeter of the record switch 210 and/or the play switch 205. The switch guard 125 is adapted to prevent accidental triggering of the record switch 210 and the play switch 205 by offsetting the top of each switch 210, 205 from the effective top 105 of the housing 100. In other words, the switch guard 125 effectively raises the top 105 of the housing 100 in an area surrounding the record switch 210 and the play switch 210, so that an individual must insert his or her finger to a position below the top 105 surface of the housing 100 to trigger a switch 205, 210.

To assist in the recording process, the microphone 215 can include a plurality of recording access slots 220 adapted to effectively receive audio (sound waves), which can then be converted into a first electronic signal by the microphone 215. Accordingly, the received audio contains fewer distortions or static. Also, the speaker 225 can include a plurality of sound escape slots 230 adapted to assist the speaker 225 in the emission of audio after converting a second electronic signal. Accordingly, the emitted audio contains fewer distortions or static.

The user interface 200 can further comprise a message indicator 240 and a record toggle 245. The message indicator 240 is adapted to indicate whether audio is currently stored on the audio recording and playback device 10. Generally, the message indicator 240 is positioned on the top 105 of the housing 100, facing outwardly. In a preferred embodiment of the present invention, the message indicator 240 is a light-emitting diode (LED), such that the LED is illuminated when audio is currently stored on the audio recording and playback device 10 and not illuminated when no audio is currently stored on the audio recording and playback device 10. In another embodiment of the present invention, the message indicator 240 can include a liquid-crystal display (LCD), an audio alarm, or other suitable visual or audible indicator.

The record toggle 245 includes a locked and an unlocked position, such that when the record toggle 245 is in the locked position, the record switch 210 is deactivated, thereby preventing the user from recording audio onto the audio recording and playback device 10. When the record toggle 245 is in the unlocked position, the record switch 210 is capable of activation by the user for recording. The record toggle 245 is generally positioned on the bottom 110 of the housing 100, facing outwardly. During use, the user can write-protect the stored audio, by moving the record toggle 245 into the locked position.

One skilled in the art will recognize that a user interface 200 may be implemented in multiple configurations and is typically displayed to a user from the top 105 and/or bottom 110 of the housing 100. The user interface 200 generally receives input from a user by means of an input device such as, but not limited to, the play switch 205, record switch 210, and/or microphone 215. In a preferred embodiment of the present invention, the user interface 200 can include a membrane switch or keypad overlay, such as membrane switch designs and overlays as provided by Pannam Imaging of Cleveland, Ohio. Components of the user interface 200, therefore, can be integrated into an overlay of, for example, polycarbonate or polyester having a thickness between 0.005 and 0.015 mils. Further, the overlay can be incorporated within the housing 100, such that the overlay acts as the top 105 of the housing 100.

In an alternative embodiment of the present invention, the user interface 200 can further comprise a stop switch and a pause switch. The stop switch is adapted to halt the audio recording and playback system 300 from recording audio or playing back the stored audio. If the stop switch is activated, the recording and playback system 300 returns to the standby mode, wherein subsequent recording or playing back of audio must occur from the beginning of the process. The pause switch is adapted to temporarily suspend the audio recording playback system 300, such that the user can then continue playing the audio or recording audio from where the user left off prior to activating the pause switch. Generally, the stop switch and pause switch are positioned on the top 105 of the housing 100.

Further, the user interface 200 can also include a recording indicator that indicates when the audio recording and playback device 10 is in the recording mode and a security mechanism, such as, but not limited to, additional key switches for entering a passcode, a voice recognition system for verifying a user's passphrase before permitting access to playback or recording modes, or a biometric system that reads biometric data for verification prior to providing access to playback or recording modes.

In yet another embodiment of the present invention, the user interface 200 can exclude the record switch 210 and microphone 215, such that the audio recording and playback device 10 is adapted to only allow a prerecorded message to be played back and, therefore, would not have the functionality for recording additional audio.

As illustrated in FIG. 2, the audio recording and playback device 10 can further include an audio recording and playback system 300 adapted to record and playback audio. The audio recording and playback system 300 includes a combination of components of the user interface 200 with a recording and playback unit 305, a memory storage device 310, and a power supply 315. More specifically, the audio recording and playback system 300 includes the interaction between the play switch 205, record switch 210, microphone 215, speaker 225, message indicator 240, record toggle 245, recording and playback unit 305, memory storage device 310, and power supply 315. The recording and playback unit 305, memory storage device 310, and power supply 315 are generally positioned within the cavity defined by the top 105 and bottom 110 of the housing 100.

The recording and playback unit 305 comprises all hardware and software components necessary to perform the functionality as described herein. The recording and playback unit 305 is in communication with the play switch 205, record switch 210, microphone 215, speaker 225, message indicator 240, record toggle 245, memory storage device 310, and power supply 315. The recording and playback unit 305 is adapted to convert signals and data as required to record and playback audio during the recording mode and playback mode of the audio recording and playback device 10.

Once a user triggers the record switch 210, the recording and playback unit 305 receives a signal from the record switch 210 indicating that audio should be recorded. Prior to recording any received audio, the recording and playback unit 305 communicates with the record toggle 245 to determine if the record toggle 245 is in the locked or unlocked position. If the record toggle 245 is in the locked position, the recording and playback unit 305 does not enter the recording mode and, therefore, does not record received audio. The recording and playback unit 305, however, can enter the playback mode when the record toggle 245 is in the locked position.

If the record toggle 245 is in the unlocked position, then the recording and playback unit 305 enters the recording mode, where the recording and playback unit 305 receives the first electronic signal from the microphone 215. The record and playback unit 305 is adapted to convert the first electronic signal into digital data, which is then provided to the memory storage device 310 for storage. Once the digital data is stored on the memory storage device 310, the recording and playback unit 305 provides a signal to the message indicator 240, thereby indicating to the user that audio has been stored on the audio recording and playback device 10. The recording and playback unit 305 then returns to the standby mode.

Once the user triggers the play switch 205, the recording and playback unit 305 enters the playback mode, where the recording and playback unit 305 receives the stored digital data, if any, from the memory storage device 310. The record and playback unit 305 is adapted to convert the digital data to a second electronic signal, which is then provided to the speaker 225. The speaker 225 then emits the audio represented by the second electronic signal. Once the speaker has finished emitting the audio, the record and playback unit 305 then returns to the standby mode.

In an alternative embodiment of the present invention, the recording and playback unit 305 can receive a second type of signal from the record switch 210, indicating that the received audio should be recorded subsequent to any digital data already stored in the memory storage device 310. If the second type of signal is received, the recording and playback unit 305 provides a separator signal (such as a beep) to the memory storage device 310 to be stored after any already stored digital data. The recording and playback unit 305 can then provide the newly created digital data to the memory storage device 310 to be recorded subsequent to the separator signal. The recording and playback unit 305 then returns to the standby mode.

Further, the recording and playback unit 305 can receive a third type of signal from the record switch 210, indicating that all digital data already stored in the memory storage device 310 should be erased. If the third type of signal is received, the recording and playback unit 305 removes all digital data from the memory storage device 310, and then returns to the standby mode.

One skilled in the art will recognize that the recording and playback unit 305 can include a computer processor and software for performing the above-mentioned functionality. Further, the recording and playback unit 305 can include the memory storage device 310 and power supply 315, such that the memory storage device 310 and power supply 315 are integrated with the recording and playback unit 305. In a preferred embodiment of the present invention, the recording and playback unit 305 can include a complementary metal oxide semiconductor (CMOS) audio recording device having an integrated oscillator, microphone preamplifier, automatic gain control, anti-aliasing filter, smoothing filter, speaker amplifier, and high density multi-level storage array, such as, for example, the ISD2560 ChipCoder® device as provided by Winbond Electronics Corporation of Taiwan.

The memory storage device 310 is adapted to receive, store, and provide digital data to the recording and playback unit 305. Further, the memory storage device 310 is typically configured to have a storage capacity of approximately or no more than sixty seconds of audio data. Generally, the memory storage device 310 can be a memory device capable of storing and retrieving data including, but not limited to, volatile and/or non-volatile memory. One skilled in the art will recognize that non-volatile memory can include a variety of memory types including, but not limited to, electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), or any other medium which may be used to store the desired information. Further, volatile memory may include, but is not limited to, a variety of memory types and devices including, but not limited to, random access memory (RAM), dynamic random access memory (DRAM), synchronous dynamic random access memory (SDRAM), double data rate synchronous dynamic random access memory (DDR-SDRAM), registers, or the like.

The power supply 315 is adapted to provide energy to the recording and playback unit 305 and, if necessary, other components of the audio recording and playback device 10. The power supply 315 preferably includes a battery, such as, but not limited to, the liquid and nanostructured substrate batteries provided by mPhase Technologies of Norwalk, Conn. and Lucent Technologies of Murray Hill, N.J. The power supply 315 is preferably made of ultra-thin layered material, with each layer weighing less than a gram and having a thickness of approximately 0.5 mils.

One skilled in the art will recognize that the housing 100, user interface 200, and audio recording and playback system 300, and all of the components and/or elements thereof can be made of a variety of suitable materials including, but not limited to, plastic, rubber, metal, ceramic, or other suitable materials or a combination thereof. Accordingly, the audio recording playback device 10 is potentially disposable, yet reusable. Preferably, however, the net weight of the components of the audio recording playback device 10 is approximately or less than 1.5 ounces.

The compact, lightweight, low cost (potentially disposable) and convenience of the present invention makes quick audio recording, such as voice notes, a practical method of communication. Numerous advantages of voice notes over standard written notes include: saving time, as individuals can generally speak faster than they can write; encouraging more detailed messages to be left for a recipient, as it takes less time to leave a voice recording; allowing quick identification of the originator of the communication by voice, which is often more reliable than identification by handwriting; and allowing the speaker to indicate by the tone of their voice subtle meanings which are often misunderstood when only reading a written note. For example, the salutation “hello” can be said in ways that indicate affection, anger, indifference, humor, tiredness, urgency, and a variety of other meanings. Almost any saying or phrase can be verbalized in different ways that have very different meanings, without the need to describe emotion as is required by written notes. Such shades of meanings are easily communicated with tone of voice, but they are much more difficult to communicate in writing.

Various examples of use of the present invention include, but are not limited: executives and managers communicating with each other more quickly and in more detail; simple requests to and from employees can be more easily and quickly transmitted; a receptionist can use the present invention to relay messages when voice mail is unavailable or the caller does not wish to use it; doctors can dictate a voice note to be attached to a chart that can then be later transcribed; personal messages to loved ones can be more powerful and meaningful; the present invention can be included in all kinds of greeting cards and letters to add extra depth and personalization; a letter sent to a soldier overseas could be much more powerful with a voice note; “to do” lists and reminders can be done verbally with much greater speed than writing; advertising such as sending a verbal/audio message to prospective buyers adds a dimension that is missing in direct mail; product descriptions can be recorded so potential buyers in a retail store can easily compare similar products by simply listening to a short presentation; and military superiors could use such a device to dictate orders.

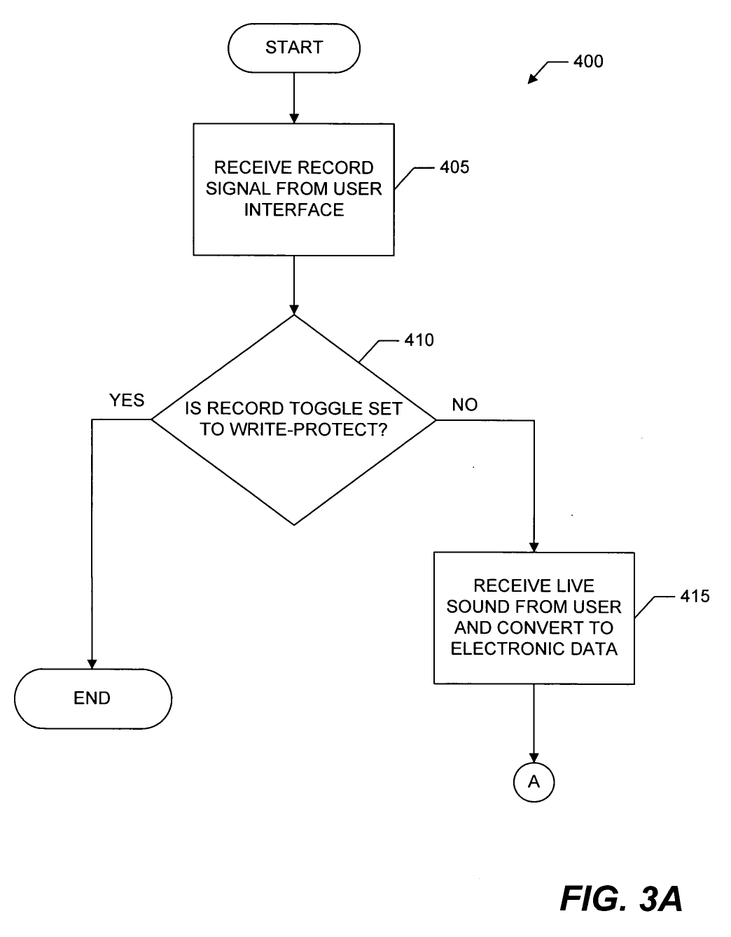

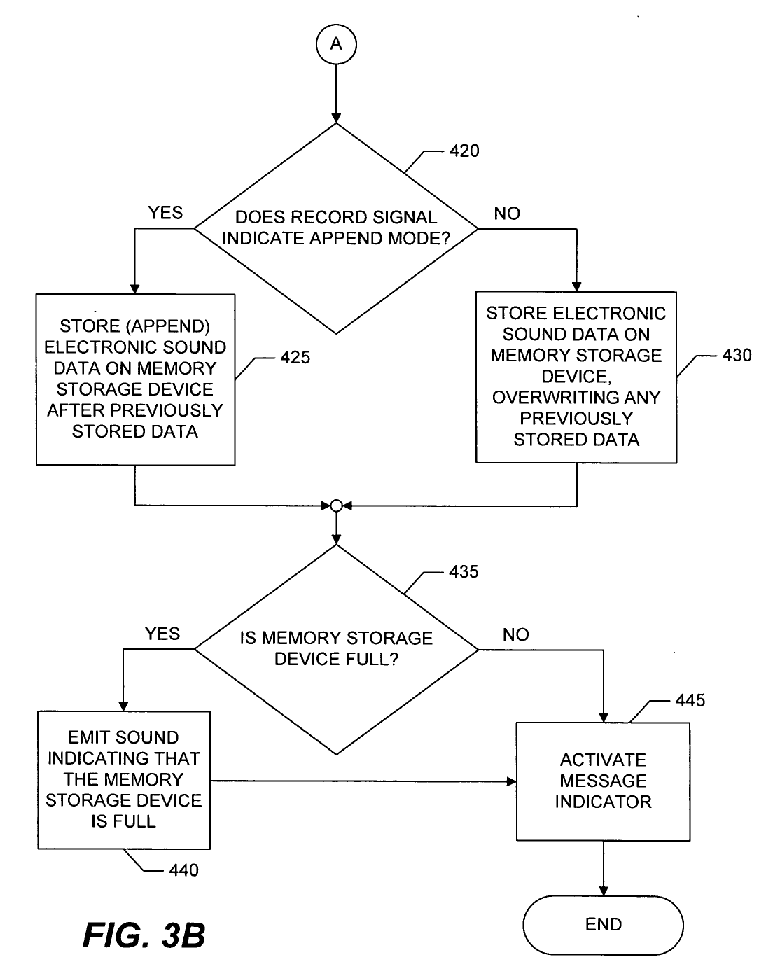

FIGS. 3A-3B illustrate a flow diagram representation of a method 400 of recording audio on an audio recording and playback device 10 in accordance with preferred embodiments of the present invention. As described above, a user can utilize the audio recording and playback device 10 to record audio for subsequent playback.

At 405 and beginning in the standby mode, the recording and playback unit 305 begins by receiving a record signal from the record switch 210 of the user interface 200. For example, the record switch 210 can generate a record signal when the user depresses the record switch 210 once. The recording and playback unit 305, at 410, then determines whether the record toggle 245 is in the locked position (e.g., set to write-protect data). If the recording and playback unit 305 determines that the record toggle 245 is in the locked position, then the recording and playback unit 305 remains in the standby mode and halts operation in accordance with method 400. If at 410, however, the recording and playback unit 305 determines that the record toggle 245 is not in the locked position (e.g., the record toggle 245 is in the unlocked position), then the recording and playback unit 305 enters the recording mode and proceeds to 415 where live sound or audio is received from the user by the microphone 215.

The microphone 215 receives the live sound and converts it to a first electronic signal. The first electronic signal is then provided to the recording and playback unit 305. Next, at 420, the recording and playback unit 305 determines if the received record signal indicates an append mode. For example, instead of depressing the record switch 210 once, the user can depress the record switch 210 twice to indicate that the record switch 210 should send an append mode record signal to the recording and playback unit 305.

If the recording and playback unit 305 determines that the received record signal indicates an append mode, then the recording and playback unit 305 proceeds to 425 where the recording and playback unit 305 converts the first electronic signal into digital data and provides a separator signal and the digital data to the memory storage device 310 for storage. The memory storage device 310 stores the separator signal and the digital data after any previously stored data, such that the received live audio is “appended” to the audio already stored on the memory storage device 310. The recording and playback unit 305 then proceeds to 435, described below.

If at 420, however, the recording and playback unit 305 determines that the received record signal does not indicate an append mode, then the recording and playback unit 305 proceeds to 430, where the recording and playback unit 305 converts the first electronic signal to digital data and provides the digital data to the memory storage device 310 for storage. The memory storage device 310 overwrites any data previously recorded on the memory storage device 310.

Next, at 435, the recording and playback unit 305 determines whether the memory storage device 310 is full. If the recording and playback unit 305 determines that the memory storage device 310 is full, then the recording and playback unit 305 provides a sound indicator to the speaker 225, which is emitted to the user to indicate that the memory storage device 310 is full and that no additional room is available for additional audio. The recording and playback unit 305 then proceeds to 445, described below.

If at 435, however, the recording and playback unit 305 determines that the memory storage device 310 is not full, then the recording and playback unit 305 proceeds to 445 where the recording and playback unit 305 activates the message indicator 240, thereby indicating to the user that audio is currently stored on the audio recording and playback device 10. The recording and playback unit 305 then returns to the standby mode and halts operation in accordance with method 400.

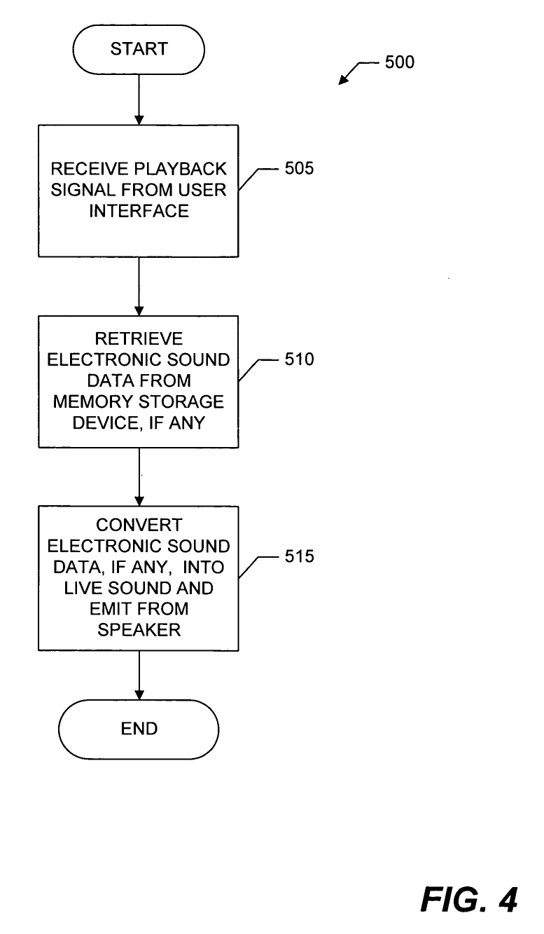

FIG. 4 illustrates a flow diagram representation of a method 500 of playing back audio stored on an audio recording and playback device 10 in accordance with preferred embodiments of the present invention. As described above, a user can utilize the audio recording and playback device 10 to playback audio currently stored in the memory storage device 310.

At 505 and beginning in the standby mode, the recording and playback unit 305 begins by receiving a playback signal from the playback switch 205 of the user interface 200. For example, the playback switch 205 can provide a playback signal when the user depresses the playback switch 205 once. The recording and playback unit 305 then enters the playback mode and proceeds to 510 where the recording and playback unit 305 retrieves the stored digital data (if any) from the memory storage device 310. The recording and playback unit 305 then converts the received digital data into a second electronic signal. Next, at 515 the recording and playback unit 305 provides the speaker 225 the second electronic signal. The speaker 225 converts the second electronic signal into live sound, which is then emitted from the speaker 225 to the user. The recording and playback unit 305 then returns to the standby mode and halts operation in accordance with method 500.

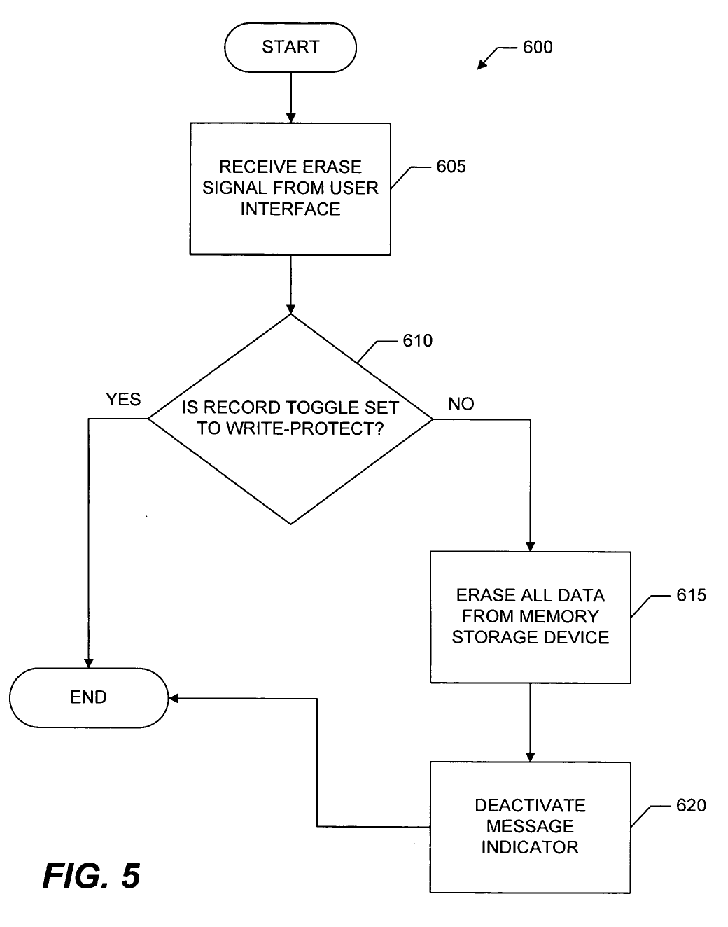

FIG. 5 illustrates a flow diagram representation of a method 600 of deleting stored audio from an audio recording and playback device 10 in accordance with preferred embodiments of the present invention. As described above, a user can erase the stored audio on the memory storage device 310 of the audio recording and playback device 10.

At 605 and beginning in the standby mode, the recording and playback unit 305 begins by receiving an erase signal from the record switch 210 of the user interface 200. For example, the record switch 210 can provide an erase signal when the user depresses and holds the record switch 210 for five consecutive seconds. The recording and playback unit 305 then proceeds to 610 where recording and playback unit 305 determines whether the record toggle 245 is in the locked position (e.g., set to write-protect data). If the recording and playback unit 305 determines that the record toggle 245 is in the locked position, then the recording and playback unit 305 remains in the standby mode and halts operation in accordance with method 600. If at 610, however, the recording and playback unit 305 determines that the record toggle 245 is not in the locked position (e.g., the record toggle 245 is in the unlocked position), then the recording and playback 305 enters the erase mode and proceeds to 615 where the recording and playback unit 305 signals the memory storage device 310 to erase all stored digital data. After the memory storage device 310 has purged all previously stored data, the recording and playback unit 305 proceeds to 620 where the recording and playback unit 305 deactivates the message indicator 240. The user will now be informed that there is no audio recorded on the memory storage device 310. The recording and playback unit 305 then returns to the standby mode and halts operation in accordance with method 600.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A disposable and reusable audio recording and playback device comprising:
a microphone for receiving a first sound wave, wherein the microphone is adapted to convert the first sound wave into a first electronic signal;
a speaker for receiving a second electronic signal, wherein the speaker is adapted to convert the second electronic signal into a second sound wave which is emitted from the speaker;
a recording and playback unit in communication with the microphone and the speaker, such that the recording and playback unit is adapted to convert the first electronic signal received from the microphone into digital data during a recording mode and is adapted to convert the digital data into the second electronic signal during a playback mode;
a memory storage device adapted to store the digital data;
a power supply for supplying power to at least one of the microphone, speaker, recording and playback unit, and memory storage device; and
a housing adapted to receive the microphone, speaker, recording and the playback unit, memory storage device, and power supply, wherein the housing includes an attachment mechanism for attaching the housing to an object.

2. The audio recording and playback device of claim 1, further comprising:
a play switch for activating the recording and playback unit into the playback mode, wherein the recording and playback unit provides the second electronic signal to the speaker;
a record switch for activating the recording and playback unit into the recording mode, wherein the recording and playback unit provides the generated digital data to the memory storage device for storage; and
at least one switch guard adapted to prevent accidental activation of the recording and playback unit, wherein a first switch guard is positioned around a perimeter of the record switch.

3. The audio recording and playback device of claim 2, wherein a second switch guard is positioned around a perimeter of the play switch.

4. The audio recording and playback device of claim 2, further comprising a stop switch for deactivating the recording and playback unit from at least one of the recording mode and the playback mode.

5. The audio recording and playback device of claim 1, further comprising a record toggle having an unlocked position and a locked position, wherein the recording and playback unit is permitted to provide the digital data to the memory storage device for storage when the record toggle is in the unlocked position, but the recording and playback unit is not allowed to provide the digital data to the memory storage device for storage when the record toggle is in the locked position.

6. The audio recording and playback device of claim 1, further comprising a message indicator for indicating that digital data is stored on the memory storage device.

7. The audio recording and playback device of claim 6, wherein the message indicator comprises a light-emitting diode (LED), such that the light-emitting diode is illuminated when digital data is stored on the memory storage device.

8. The audio recording and playback device of claim 1, wherein the attachment mechanism includes a clip.

9. The audio recording and playback device of claim 1, wherein the attachment mechanism includes a clamp.

10. The audio and recording and playback device of claim 1, wherein the attachment mechanism includes a magnet.

11. The audio and recording and playback device of claim 1, wherein the memory storage device includes flash memory.

12. The audio and recording and playback device of claim 1, wherein the memory storage device is capable of storing digital data representing audio of no more than sixty seconds in duration.

13. The audio and recording and playback device of claim 1, wherein the power supply includes a battery.

14. The audio and recording and playback device of claim 1, wherein the housing includes a length dimension of not more than 3.25 inches, a width dimension of not more than 2 inches, and a thickness dimension of not more than 4 millimeters.

15. A disposable and reusable audio recording and playback device comprising:
a recording and playback unit adapted to convert a first acoustical vibration to digital data during a recording mode and convert the digital data to a second acoustical vibration during a playback mode;
a memory storage device adapted to store the digital data during the recording mode;
a power supply for supplying power to at least one of the recording and playback unit and memory storage device; and
a housing adapted to receive the recording and the playback unit, memory storage device, and power supply, wherein the housing includes a length dimension of not more than 3.25 inches, a width dimension of not more than 2 inches, and a thickness dimension of not more than 4 millimeters

16. The audio recording and playback device of claim 15, further comprising:
a play switch for activating the recording and playback unit into the playback mode;
a record switch for activating the recording and playback unit into the recording mode; and
at least one switch guard adapted to prevent accidental activation of the recording and playback unit, wherein a first switch guard is positioned around a perimeter of the record switch.

17. A method of utilizing an audio recording and playback device, the method comprising:
receiving a record signal from a user interface;
determining whether a record toggle is in an unlocked position;
if the record toggle is in the unlocked position, then performing a first sequence comprising:
receiving a first sound wave;
converting the first sound wave into a first electronic signal;
converting the first electronic signal into digital sound data;
determining whether the received record signal indicates an append mode; and
if the received record signal indicates an append mode, then storing the digital sound data on a memory storage device at a location subsequent to all digital data already stored on the memory storage device;
if the received record signal does not indicate an append mode, then storing the digital sound data on a memory storage device, wherein all previously stored digital data is overwritten.

18. The method of claim 17, the method further comprising the step of activating an alarm if the memory storage device cannot store any additional digital sound data.

19. The method of claim 17, the method further comprising the step of activating a message indicator after the digital sound data has been stored on the memory storage device.

20. The method of claim 17, the method further comprising:
receiving a playback signal from the user interface;
retrieving the digital sound data from the memory storage device;
converting the digital sound data into a second electronic signal;
converting the second electronic signal into a second sound wave, wherein the second sound wave is emitted from a speaker.
